(19) United States
(12) Patent Application Publication
(10) Pub. No.: US 2026/0184627 A1
(43) Pub. Date: Jul. 2, 2026

(54) SYSTEMS AND METHODS FOR LASER MICROMACHINING SUBSTRATES USING A LIQUID-ASSIST MEDIUM AND ARTICLES FABRICATED BY THE SAME

(71) Applicant: CORNING INCORPORATED, CORNING, NY (US)

(72) Inventors: David Mark Lance, Elmira, NY (US); Alexander Mikhailovich Streltsov, Corning, NY (US)

(21) Appl. No.: 19/129,528

(22) PCT Filed: Nov. 27, 2023
(86) PCT No.: PCT/US2023/081057

§ 371 Date: May 13, 2025

Related U.S. Application Data
(60) Provisional application No. 63/428,822, filed on Nov. 30, 2022.

(51) Int. Cl. C03C 23/00

(52) U.S. Cl. CPC C03C 23/0025

(57) ABSTRACT

A method of processing a substrate includes disposing the substrate into a liquid-assist medium such that the substrate is in an orientation that is within ten degrees of vertical. The substrate is attached to a mount assembly comprising a window-substrate and one or more spacers located at a surface of the window-substrate. The substrate is attached to the one or more spacers such that a gap is present between a first surface of the substrate and the surface of the window-substrate. The liquid-assist medium is present within the gap and at a back surface of the substrate. The method further includes directing a pulsed laser beam to form a focus spot having an initial position in the liquid-assist medium behind the back surface, and moving the focus spot through a body of the substrate to create a modification that forms a feature.

### CROSS-REFERENCE TO RELATED APPLICATIONS

This application claims the benefit of priority under 35 U.S.C. § 119 of U.S. Provisional Application Ser. No. 63/428,822 filed on Nov. 30, 2022, the content of which is relied upon and incorporated herein by reference in its entirety.

### FIELD

The disclosure is directed to systems and methods for laser micromachining features in substrates and, more particularly systems and methods for laser micromachining features in substrates for optical components using a liquid-assist medium.

### BACKGROUND

Precision machining of materials is used for many applications. Precision machining allows for the formation of miniature features in materials. Such features include holes, slots, grooves, and chamfers. Traditional techniques for precision machining involve mechanical methods (e.g., cutting, sawing, drilling, and scoring) or chemical methods (e.g., etching).

Adaptation of traditional techniques to more demanding applications, however, has proven to be challenging. There is increasing demand for machining finer features and for forming features in a wider variety of materials. There is currently great interest in the precision machining of hard dielectric materials and in forming high aspect ratio features with a high degree of precision. Computer numerical control (CNC) machining, for example, has challenges in drilling holes with a diameter smaller than 100-200 μm in glass, especially when the aspect ratio exceeds 10-20.

Laser-damage-and-etch processes have been used to form small features in dielectric substrates, such as glass substrates. In this process, an ultrafast-laser is used to create damage tracks within the substrate. A subsequent etching process is used to “open up” the damage track to create the desired feature. However, this process requires two steps and is therefore slow. Further, the laser-damage-and-etch process typically results in “hourglass” shaped through-holes that deviate from a cylindrical profile.

Laser ablation has also been used to fabricate features within dielectric substrates. However, laser ablation results in rough feature walls, ablated debris precipitation, as well as chipping at the feature openings. Further, features cannot be fabricated in close proximity to one another due to the difference in the index of refraction between air and the substrate and the clipping of the laser beam due to the edge of an adjacent drilled feature.

Some approaches have included providing a liquid at the rear working surface of the substrate. However, these approaches have several disadvantages, such as spilled liquid that leaves nanoparticles on the front surface of the machined substrate, which are difficult to clean, and the drilled holes cannot be placed close to each other and to the edge of the substrate because of laser beam clipping.

Consequently, there exists an unresolved need for alternative systems and methods for laser micromachining features into dielectric substrates.

### SUMMARY

Various embodiments of systems and methods for laser micromachining features into dielectric substrate and resulting articles are disclosed. Embodiments of the present disclosure enable the fabrication of features having high-quality walls that are within close proximity to each other by use of a liquid-assist medium that is located on both surfaces of the substrate. More particularly, the substrate is arranged vertically in an enclosure such as a cuvette such that the liquid-assist medium contacts the rear working surface of the substrate, and fills a gap between a transparent window-substrate and the front surface of the substrate. Providing the liquid-assist medium at the front surface of the substrate reduces front-surface contamination with process byproducts, reduces front surface chipping by reducing acoustic shock at the front surface, decreases the minimum distance between holes, provides the ability to place holes close to the edge of the substrate, and provides the ability to create precision features on the edge of the substrate.

In one embodiment, a method of processing a substrate includes disposing the substrate into a liquid-assist medium such that the substrate is in an orientation that is within ten degrees of vertical. The substrate is attached to a mount assembly comprising a window-substrate and one or more spacers located at a surface of the window-substrate. The substrate is attached to the one or more spacers such that a gap is present between a first surface of the substrate and the surface of the window-substrate. The liquid-assist medium is present within the gap and at a back surface of the substrate. The method further includes directing a pulsed laser beam through the window-substrate, the first surface and the back surface to form a focus spot having an initial position in the liquid-assist medium behind the back surface, moving the focus spot over a motion path from the initial position in the liquid-assist medium through a body of the substrate in a general direction from the back surface to the first surface to create a modification of a material of the substrate that defines a core portion of the body of the substrate, and removing the core portion from the body of the substrate to form a feature in the substrate.

In another embodiment, a method of processing a substrate includes attaching the substrate to a mount assembly, wherein the mount assembly comprises a window-substrate and one or more spacers located at a surface of the window-substrate, and the substrate is attached to the one or more spacers such that a gap is present between a first surface of the substrate and the surface of the window-substrate. The method further includes attaching the mount assembly to an opening of a cuvette such that the substrate is in an orientation that is within ten degrees of vertical, filling the cuvette with a liquid-assist medium such that the liquid-assist medium is present within the gap and at a back surface of the substrate, wherein the gap has a width within a range of 0.06 mm and 1.6 mm, including endpoints, and directing a pulsed laser beam through the window-substrate, the first surface and the back surface to form a focus spot having an initial position in the liquid-assist medium behind the back surface. A difference in a refractive index of the liquid-assist medium and a refractive index of the substrate is less than 0.2. The method also includes moving the focus spot over a motion path from the initial position in the liquid-assist medium through a body of the substrate in a general direction from the back surface to the first surface to create a modification of a material of the substrate that defines a core portion of the body of the substrate and removing the core portion from the body of the substrate to form a feature in the substrate.

In yet another embodiment, a system for processing a substrate includes a laser system including a laser operable to produce a pulsed laser beam and an optical assembly operable to focus the pulsed laser beam to a focus spot and move the focus spot along a circular path, a three-axis stage, a cuvette mounted to the three-axis stage, the cuvette having an opening in a wall, and a mount assembly having a window-substrate and one or more spacers located at a surface of the window-substrate, wherein the mount assembly is attached to the cuvette such that it seals the opening. The system further includes a substrate mounted to the one or more spacers such that a gap is present between a first surface of the substrate and the surface of the window-substrate, and the substrate is in an orientation that is within ten degrees of vertical. The cuvette is operable to be filled with a liquid-assist medium such that the liquid-assist medium is present within the gap and at the back surface of the substrate.

In yet another embodiment, an article includes a first surface, a second surface opposite the first surface such that the article has a thickness between the first surface and the second surface, and a through-hole extending from the first surface to the second surface. The through-hole has a diameter of less than 200 μm. An aspect ratio of the thickness to the diameter is at least 10:1. The through-hole has a profile from the first surface to the second surface that deviates less than 5 μm from a predefined profile.

In yet another embodiment, an article includes a first surface, a second surface opposite the first surface such that the article has a thickness between the first surface and the second surface, and a first through-hole and a second through-hole extending from the first surface to the second surface. The first through-hole and the second through-hole each have a diameter of less than 200 μm, and an edge of the first through-hole is within 10 μm and 100 μm from an edge of the second through-hole.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure and are incorporated into and constitute a part of this specification. The drawings illustrate various embodiments and together with the description serve to explain the principles and operation.

### BRIEF DESCRIPTION OF THE FIGURES

FIG. 1A is a schematic elevated view of an example liquid-assisted laser-based micromachining system for processing a substrate according to one or more embodiments described and illustrated herein;

FIG. 1B is a side view of the liquid-assist laser-based micromachining system of FIG. 1A;

FIG. 2A is a perspective view of the cuvette of the liquid-assist laser-based micromachining system of FIGS. 1A and 1B according to one or more embodiments described and illustrated herein;

FIG. 2B is a close-up view of the substrate and the cuvette showing an initial focus position of the focus spot within the liquid-assist medium and adjacent the interface between the liquid-assist medium and the back (working) surface of the substrate according to one or more embodiments described and illustrated herein;

FIG. 2C schematically depicts a helical path of a focus spot produced by a focused laser beam according to one or more embodiments described and illustrated herein;

FIG. 2D shows the motion path of the focus spot used to form a helical modification to the material that constitutes the body of the substrate as part of the process of forming a feature in the substrate according to one or more embodiments described and illustrated herein;

FIG. 2E is similar to FIG. 2D and shows the final helical modification and the resulting core portion defined by the final helical modification, with the close-up inset showing example micromachined regions that constitute the modification according to one or more embodiments described and illustrated herein;

FIG. 3 is a top perspective view of an article having laser micromachined features according to one or more embodiments described and illustrated herein;

FIG. 4A is a microscope photograph of through-holes fabricated without having a liquid-assist medium at a front surface of the substrate;

FIG. 4B is a microscope photograph of through-holes fabricated with having a liquid-assist medium at both the front surface and the rear surface of the substrate according to one or more embodiments described and illustrated herein;

FIG. 5 is a perspective view of a substrate having a through-hole and a dicing plane for evaluating wall quality according to one or more embodiments described and illustrated herein;

FIG. 6A schematically illustrates the fabrication of a feature adjacent to a previously drilled feature according to one or more embodiments described and illustrated herein;

FIG. 6B is a microscope photograph of through-holes fabricated close to an edge of a substrate according to one or more embodiments described and illustrated herein;

FIG. 7 schematically depicts various features fabricated at an edge of a substrate according to one or more embodiments described and illustrated herein; and

FIG. 8 is a flowchart of an example method for laser micromachining features in a substrate according to one or more embodiments described and illustrated herein.

### DETAILED DESCRIPTION

References will now be made in detail to the embodiments of the disclosure, examples of which are illustrated in the accompanying drawings. Whenever possible, like reference numbers will be used to refer to like components or parts.

### Definitions and Explanation of Select Terms

The following definitions and explanations regarding certain terms apply to the specification and claims that follow.

“Include,” “includes,” or like terms means encompassing but not limited to, that is, inclusive and not exclusive.

The term “consists of” or “consisting of” and like terms are understood as being a special case of the more general term “comprising” or “comprises,” so that the expression “A comprises B” and like expressions also includes “A consists of B” and like terms as a special case.

The terms “downstream” and “upstream” are used to describe positions of objects relative to a direction of light travel, so that A upstream (downstream) of B means that light is incident upon A before (after) B.

The indefinite article “a” or “an” and its corresponding definite article “the” as used herein means at least one, or one or more, unless specified otherwise.

As used herein, the aspect ratio of a feature refers to the ratio of a linear dimension of the feature normal to the incident surface to the smallest linear dimension of the feature orthogonal to the linear dimension of the feature normal to the incident surface.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other, but are otherwise joined to each other through one or more intervening elements. Elements in contact may be rigidly or non-rigidly joined. Contacting refers to placing two elements in direct or indirect contact. Elements in direct (indirect) contact may be said to directly (indirectly) contact each other.

As used herein, a material is “transparent” to a wavelength of light if the internal transmission of light at the wavelength is greater than 80%. Preferably, the internal transmission is greater than 90%, or greater than 95%. As used herein, internal transmission refers to transmission exclusive of reflection losses.

As used herein, “working surface” refers to a surface of a substrate in contact with a liquid-assist medium in a liquid-assisted laser micromachining process.

An “optical fiber component” is any element or assembly that is used to operably support at least one optical fiber. Example optical fiber components include optical fiber guide members, optical fiber support members and optical fiber interconnection devices.

Cartesian coordinates are used in some of the Figures for reference and ease of explanation and are not intended to be limiting as to direction and/or orientation.

The abbreviation μm is short for micron or micrometer, which is 10-6 meter. The abbreviation μm and the term micron are used interchangeably herein.

Various embodiments of systems and methods for laser micromachining features into the dielectric substrate and resulting articles are disclosed. Embodiments of the present disclosure enable the fabrication of features having high-quality walls that are within close proximity to each other by use of a liquid-assist medium that is located on both surfaces of the substrate. More particularly, the substrate is arranged vertically in an enclosure such as a cuvette such that the liquid-assist medium contacts the rear working surface of the substrate, and fills a gap between a transparent window-substrate and the front surface of the substrate. Providing the liquid-assist medium at the front surface of the substrate reduces front-surface contamination with process byproducts, reduces front surface chipping by reducing acoustic shock at the front surface, decreases the minimum distance between holes, provides the ability to place holes close to the edge of the substrate, and provides the ability to create precision features on the edge of the substrate.

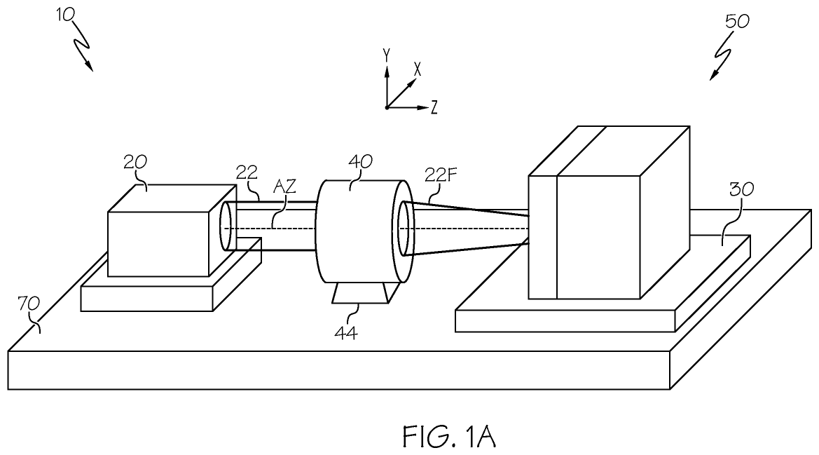

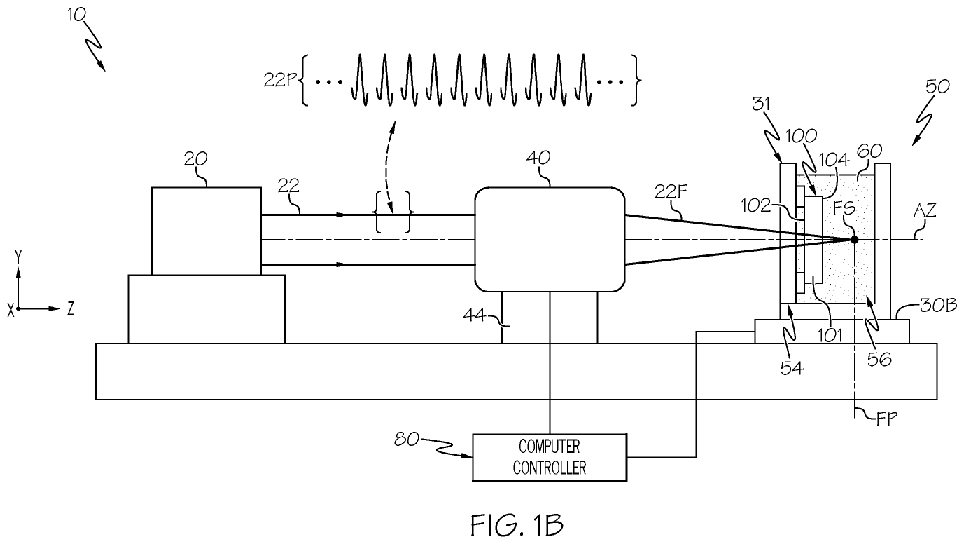

FIG. 1A is a schematic elevated view of an example liquid-assisted laser-based micromachining system (“system”) 10 for processing a transparent dielectric to form an article, such as, without limitation, an optical interconnection device for optical fibers as disclosed herein. FIG. 1B is a schematic side view of the system of FIG. 1A. The system 10 includes a laser source 20, which produces a substantially collimated laser beam 22 that passes in a direction of propagation along a system axis AZ that runs in the z-direction. In an example, the laser source 20 can include beam collimating optics (not shown) to form the substantially collimated laser beam 22.

The wavelength of the laser source 20 can be any wavelength at which the dielectric material of the substrate 100 is transparent. Typical laser wavelengths for common substrates are in the UV, visible, or infrared portions of the electromagnetic spectrum. Representative laser wavelengths include wavelengths in the range from 325 nm-1700 nm, or in the range from 400 nm-1500 nm, or in the range from 500 nm-1250 nm, or in the range from 700 nm-1100 nm. The material of the substrate may have an internal transmittance at the laser wavelength of greater than 50%, greater than 60%, greater than 70%, greater than 80%, greater than 90%, greater than 95%, or 100%.

The laser source 20 is operable to produce a pulsed laser beam 22. As shown in FIG. 1B, the laser beam 22 comprises a train of laser pulses 22P. The duration of the laser pulses 22P can vary over a range extending from the femtosecond (fs) regime to the picosecond (ps) regime. Representative pulse durations are in the range from 10 fs-100 ps, or in the range from 50 fs-50 ps, or in the range from 500 fs-50 ps, or in the range from 1 ps-100 ps, or in the range from 1 ps-10 ps. In some aspects, shorter laser pulses 22P are preferable to longer laser pulses. While not wishing to be bound by theory, it is believed that surface roughness is higher when longer laser pulses 22P are used because longer laser pulses have higher threshold pulse energies for ablation and lead to ablation of larger pieces of matter from the working surface than shorter laser pulses. On the other hand, longer laser pulses 22P allow for higher material removal rate. Based on these considerations, picosecond laser pulses provide a good combination of low surface roughness and high material removal rates.

In another example, the laser beam parameters comprise: a pulse length for the laser pulses 22P in the range from 1 to 50 ps; a laser pulse energy in the range from 10 μJ to 100 μJ; a repetition rate in the range from 1 kHz to 1 MHz or in the range from 1 kHz to 500 KHz; a focus spot size FS (defined below) in the range from 2 μm to 10 μm; a wavelength in the range from 0.3 μm to 2 μm; and a laser beam (or cuvette) translation speed in the range from 0.001 mm/s to 10 mm/s in the AZ axis direction.

The system 10 also includes a focusing optical system 40 downstream of the laser source 20 and along the system axis AZ. The focusing optical system 40 can comprise one or more optical elements such as one or more focusing lenses or focusing optics. In an example, the focusing optical system 40 can also include one or more elements that provide beam conditioning (e.g., spatial filtering, wavelength filtering, etc.) and can also include one or more elements for beam steering (e.g., rotatable mirrors, etc.). The focusing optical system 40 has a focal length FL, a numerical aperture NA and clear aperture CA.

The system 10 also includes a cuvette 50 having an interior 56 configured to contain a liquid-assist medium 60. FIG. 1A illustrates an assembled cuvette 50, while FIG. 1B illustrates a cross-section of the cuvette 50 illustrating the interior 56 and interior components, which are described below.

One example liquid includes water or consists essentially of water. Other example liquid-assist media are discussed below. In an example, the cuvette 50 can be operably supported by a movable precision x-y-z stage 30 that can move the cuvette in the x, y and z directions. In an example, the system 10 only includes the movable precision stage 30 and the laser source is substantially stationary (e.g., is movable for coarse alignment). In an example, the laser source 20, the focusing optical system 40 and the cuvette 50 are operably supported by a support base 70, such as an optical bench or like stable platform. In an example shown in FIG. 1B, a computer controller 80 is operably connected to the movable precision x-y-z stage 30 and the optional movable stage 44 to control the movement of one or both of the movable precision stages in operating the system 10 to carry out the micromachining methods described herein. The cuvette 50 has an open side 54 whose purpose is described below.

The system 10 is configured to process a transparent dielectric substrate 100 having a body 101 that defines a front surface 102 and a back surface 104. The transparent dielectric substrate 100 comprises a dielectric material, and in examples comprises a glass material, a glass-ceramic material or a crystalline material. In an example, the transparent dielectric substrate comprises sapphire. Example glasses include oxide glasses and non-oxide glasses. Preferred glasses are silica glasses, including alkali silica glasses, alkaline earth silica glasses, and borosilicate glasses. Glasses include glasses strengthened by ion exchange or thermal tempering. Example crystals include oxide crystals, such as metal oxides, and non-oxide crystals. Example glasses can include soda-lime glasses, alkaline earth boro-aluminosilicate, alkali-aluminosilicate glass, and Corning IriS™ glass.

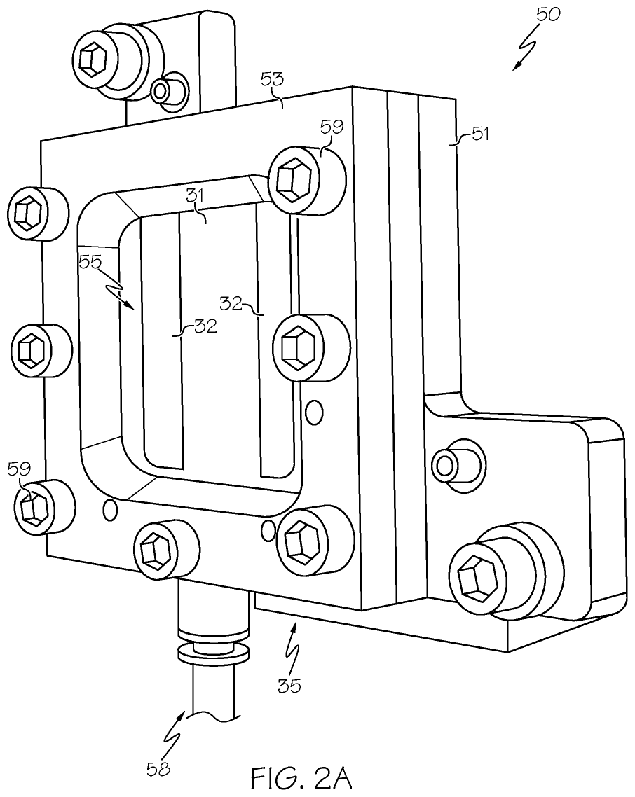

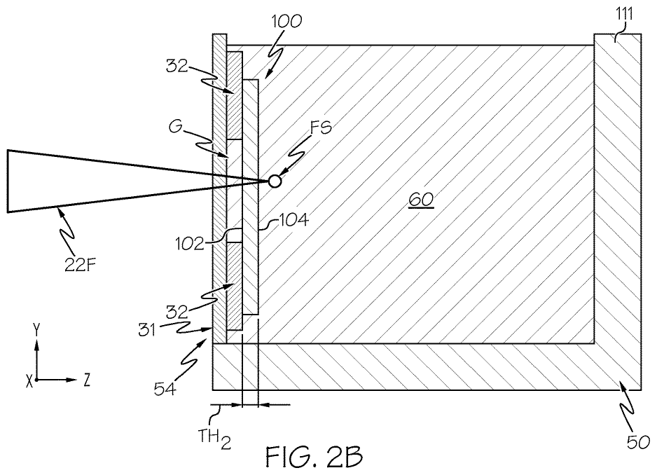

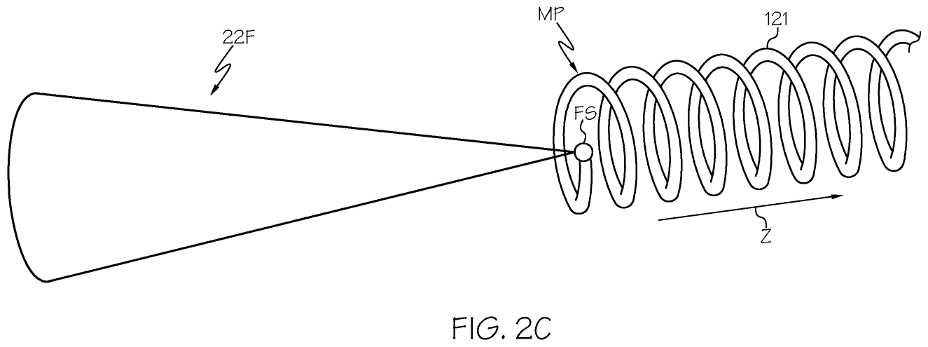

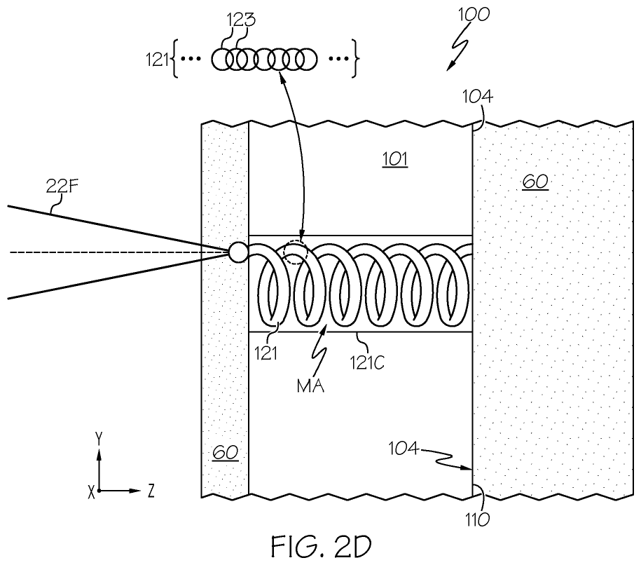

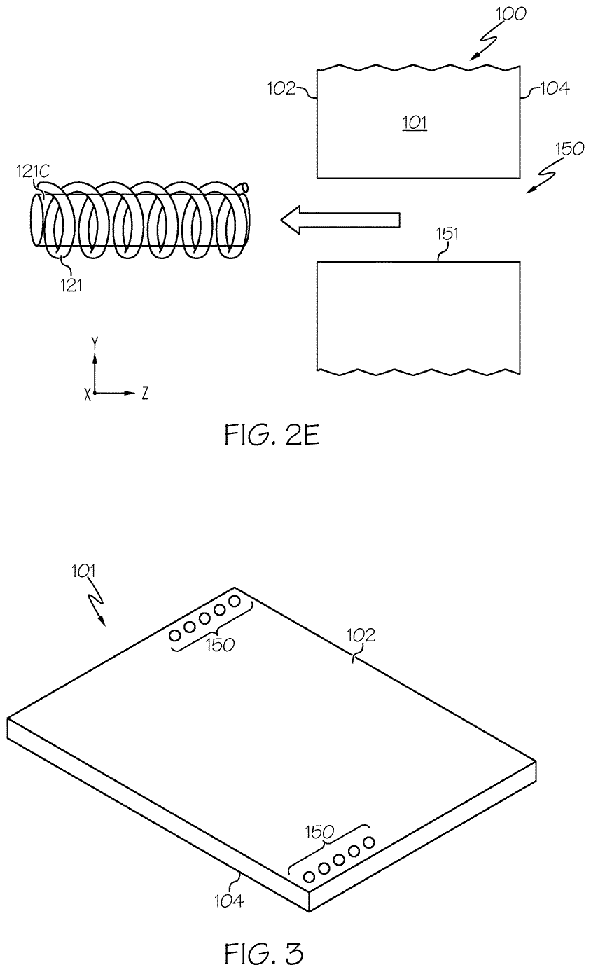

In an example, the transparent dielectric substrate (hereinafter, “substrate”) 100 is rectangular and substantially planar with substantially parallel front and back surfaces 102 and 104 and a substantially constant thickness TH₂. Other shapes for the substrate 100 can also be employed, and the rectangular and planar substrate is shown by way of example and for ease of illustration and explanation. In an example, the thickness TH₂ of the substrate 100 in the z-direction is at least 0.09 mm or at least 0.2 mm or at least 0.5 mm (FIG. 2B).

FIG. 2A is a front perspective view of an assembled cuvette 50. The example cuvette 50 generally includes a cuvette body 51 and a cover 53 that is attached to an open side of the cuvette body 51 by any means such as, without limitation, fasteners 59. The cover 53 includes an opening 55, and a transparent window-substrate 31 mounted on an interior surface of the cover 53 that seals the opening 55. The window-substrate 31 is transparent to the wavelength of the laser beam 22. For example, the window-substrate has an internal transmittance at the laser beam wavelength of greater than or equal to 80%, greater than or equal to 90%, greater than or equal to 95%, or 100%.

Two spacers 32 are attached to a surface of the window-substrate 31 that faces the interior 56 of the cuvette 50. As described in more detail below, the spacers 32 (which may include one or more spacers) are operable to provide a gap G between the window-substrate 31 and a working substrate 100. The material of the spacers 32 is such that the substrate 100 is releasably attached to the spacers 32. As a non-limiting example, pottery clay may be used for the spacers 32. The cover 53, window-substrate 31, and spacers 32 define a mount assembly 35.

As shown in FIGS. 1B and 2B, the substrate 100 is maintained within the interior 56 of the cuvette in a vertical orientation. In embodiments of the present disclosure, the substrate 100 is maintained within ten degrees of a vertical orientation. This vertical or nearly vertical orientation provides for air bubbles due to liquid convection to quickly rise and not become trapped and occlude the focused laser beam 22F. Additionally, the vertical or nearly vertical orientation allows debris from the laser process to drop away from the substrate so that it too does not occlude the focused laser beam 22F.

The example cuvette 50 further includes an opening (not shown) for providing liquid to the interior 56, and a liquid outlet 58 for draining liquid from the interior 56 of the cuvette 50 upon completion of processing.

Water is one example of a liquid-assist media 60 for liquid-assisted laser micromachining and high ablation rates. When water is used, a surfactant can be added to reduce surface tension and to prevent byproduct accumulation on the surface of the substrate 100 and to reduce the acoustic shock effect. As a non-limiting example, sodium dodecyl sulfate may be used as a surfactant. Other common surfactants may also be utilized.

Other example liquid-assist media 60 include 3M Fluorinert (e.g. FC-70) and Novec engineering liquids (e.g. 7500, 7700), solvents (e.g. methanol, ethanol, acetone, DMSO (dimethylsulfoxide)), ethylene glycol, and other liquids. Preferable attributes are low viscosity, high boiling point (e.g., greater than or equal to 80° C.), high specific heat, low surface tension (for improved precision, e.g., a surface tension of less than 50 dynes/cm at 25° C.) and high surface tension for high material removal rate (e.g., a surface tension of more than 50 dynes/cm at 25° C.). Further, the difference between the refractive index of the substrate 100 and the refractive index of the liquid-assist media 60 should be small, such as, without limitation, less than or equal to 0.2. For instance, DMSO has a refractive index of about 1.48, which differs from the typical glass refractive index of 1.45 by 0.03. Beam clipping and distortion effects are further reduced.

FIG. 2B illustrates a close-up cross-sectional view of the cuvette 50 illustrated by FIGS. 1A and 1B without the cover 53. Unlike previous systems, the spacers 32 are operable to provide a gap G between an inner surface of the window-substrate 31 and the first surface 102 of the substrate 100. The gap G should not be too small such that convection is insufficient and air bubbles become stuck between the window-substrate 31 and on the substrate 100. On the other hand, too thick of a gap G may cause laser beam distortion and poor focusing because of turbulent convection. The minimum and maximum width of the gap G may be different for different liquids. As a non-limiting example, the gap G has a width within a range of 0.06 mm and 1.6 mm, including endpoints, when the liquid-assist medium 60 is water.

The substrate 100 is disposed in system 10 so that the back surface 104 is in direct contact with the liquid-assist medium 60 of the cuvette 50. Because of the gap G, the front surface 102 of the substrate 100 is also in direct contact with the liquid-assist medium 60. In an example, the substrate 100 is also supported by the movable precision x-y-z stage 30 so that the substrate and cuvette 50 move together.

In the operation of the system 10 to carry out the micromachining methods disclosed herein, the substrate 100 is moved into a desired position relative to the system axis AZ using the movable precision x-y-z stage 30. Once in position, the laser source 20 is activated to form the substantially collimated beam 22, which is received by the focusing optical system 40. The focusing optical system 40 forms from the substantially collimated beam 22 a focused laser beam 22F that is focused to a focus spot FS at a focus position FP along the system axis AZ. The focus spot FS has a diameter defined by a Gaussian beam waist, which in an example can be in the range from 1 μm to 5 μm. The focus spot FS also has an associated Rayleigh length, which in an example is in the rage from 1.6 μm to 20 μm. An exemplary focus spot diameter is 2 μm and an exemplary Rayleigh length is 6.5 μm for applications where the substrate 100 has the form of a thin sheet of glass.

In an example, the focused laser beam 22F initially passes through the window-substrate 31, the gap G, and the substrate 100 and forms the focus spot FS within the liquid-assist medium 60. FIGS. 1B and 2B show an initial focus position FP of the focus spot FS within the liquid-assist medium 60 and adjacent an interface 110 defined by the back surface 104 (hereinafter, working surface 104) and the liquid-assist medium 60, e.g., in the liquid-assist medium within about 10 μm of the interface.

The focus spot FS is subsequently moved forward to be at or near the interface 110. The focus spot FS has sufficient intensity to alter the structure of the material that makes up the body 101 of the substrate to define a modification 121 to the material that structurally weakens the material as shown in FIG. 2D.

Next, the laser source 20 and/or the substrate 100 and cuvette 50 can be translated in the x, y and/or z directions to control the position of the focus spot FS and the shape of the feature 150 formed in the body of the substrate 100. Likewise, the movable stage 44 of the focusing optical system 40 can be used to steer the focused laser beam 22F. FIG. 2C shows an example motion path MP and modification 121 in the process of being formed by moving the focus spot FS along a helical motion path MP that includes a z-component as indicated by the arrow. In an example, the helical motion path MP can have a pitch in the range from 0.1 μm to 30 μm.

The lateral dimensions of the modification 121 can be controlled through motion of the focus spot FS over the motion path MP in the x and y directions and the depth of the feature can be controlled by movement of the focus spot over the motion path in the z direction. The dimensions of the modification 121 can also be controlled by varying the position of the focus spot FS of focused laser beam 22F. The modification 121 is ultimately used to form at least one feature in the substrate 100, as explained below.

Thus, in an example, the formation of the modification 121 begins at the working surface 104 and continues through the body 101 in the direction of the front surface 102.

In one embodiment, formation of the modification 121 includes ablation of the material that makes up the body 101 of the substrate 100. As material is removed from the working surface 104, the liquid-assist medium 60 from the cuvette 50 flows to occupy the evacuated space to maintain a wetted surface for heat removal and further micromachining. Micromachining at different depths relative to the working surface 104 is achieved by moving the focus spot FS of the focused laser beam 22F (either through variation in the focusing optical system 40 or relative motion of the laser and working surface) in the direction from the working surface 104 toward the front surface 102 of the substrate 100 over a select motion path MP. The modifications 121 can be formed in the body 101 of the substrate 100 having depths varying from a partial thickness TH₂ of the substrate to the full thickness of the substrate. In an example, the size (diameter) of the focus spot FS is selected to facilitate the flow of the liquid-assist medium 60 through the micromachined regions that define a tube-like modification 121.

FIG. 2D is a close-up view of the irradiated portion of the substrate 100 showing the completed formation of the example of a helical modification 121 formed in the body 101 of the substrate 100 by ablation by the focus spot FS moving over the example helical motion path MP of FIG. 2B. Just the liquid-assist medium 60 of the cuvette is shown for ease of illustration. Localized micromachining occurs in the vicinity of each position of the focus spot FS within the body 101 of the substrate 100 when forming the modification 121. For the helical modification 121, a helical arrangement of micromachined regions 123 is formed in the body 101 of the substrate 100, as shown in the close-up inset 11. The micromachined regions 123 define the modification 121 and constitute regions of mechanical weakness which represent a trajectory for separation of the modification 121 from the rest of the body 101 of the substrate 100. Thus, in an example, the modification 121 can comprise micromachined regions 123 in the form of microcavities created by ablation and that form contiguous channels within the material that makes up the body 101 of the substrate 100.

FIGS. 2D and 2E are close-up views of a portion of the substrate 100 and illustrate how a feature 150 in the form of a through hole can be fabricated in the body 101 by moving the focus spot FS over a helical motion path MP so that the micromachined regions that define the modification 121 extend through the thickness TH₂ of the body, as shown in FIG. 2E. FIGS. 2D and 2E show a core portion 121C of the body 101 as defined by the modification 121, wherein in FIG. 2E, the core portion is separated from the rest of the body 101 to form a through-hole feature 150. The feature 150 has an interior surface 151.

Thus, with reference again also to FIGS. 1A and 1B, in an example of the operation of the system 10, the focused laser beam 22F passes through the body 101 of the substrate 100 so that the focus spot FS resides in the liquid-assist medium 60 adjacent the interface 110 as shown in FIG. 2B. The micromachining occurs in a −z direction, i.e., counter to the +z direction of the focused laser beam 22F. That is, relative to the direction of propagation of the focused laser beam 22F, the working surface 104 is closer to the laser source 20 than the initial position of the focus spot FS, and micromachining occurs by moving the focus spot over the motion path MP that has a component in the −z direction, which is toward the working surface 104 and the laser source 20.

As noted above, a given modification 121 can be used to form a given feature 150, and multiple features can be used to form an array of features. The modifications 121 can have a variety of shapes to form a corresponding variety of features 150. Features 150 other than holes can be similarly fabricated by controlling the motion path MP of the focus spot FS relative to the body 101 of the substrate 100 to form a pattern of two or more ablated regions having a shape consistent with a desired modification 121. Cross-sectional shapes of features 150 include circular, elliptical, round, square, and rectangular. Example features 150 can extend through the entire thickness TH₂ of the substrate 100 to form through holes such as shown in FIG. 2E, or alternatively extend through a fraction of the thickness of the substrate. Generally, the features 150 can include grooves, channels, recesses, holes and slots having arbitrary cross-sectional shapes, cylindrical holes, conical holes, and holes having a combination of conical and cylindrical sections.

The features 150 can have relatively smooth interior surfaces. The features 150 are formed by using the focus spot FS of the focused laser beam 22F laser to remove portions of the material from the body 101 of the substrate. A preferred mechanism of material removal includes combination of laser ablation and material removal through acoustic shock generated by cavitating bubbles.

FIG. 3 illustrates a perspective view of an example substrate 100 having features 150 configured as through-holes formed therethrough.

To avoid heating and melting of the substrate 100, linear absorption of the focused laser beam 22F by the substrate is minimized and ablation is instead affected by non-linear optical absorption. Non-linear optical absorption occurs in transparent materials when the intensity of the laser exceeds an intensity threshold. The intensity of the laser beam 22 can be controlled by adjusting the power of the laser source and/or the focusing the laser beam by the focusing optical system 40. Non-linear optical absorption is a multiphoton absorption process that has an absorption coefficient that increases with increasing intensity. The high intensity and tight focusing of the focused laser beam 22F lead to strong non-linear absorption in a highly localized region of the material allowing for dimensional control of features 150 with precision/accuracy of 0.5 μm or smaller.

The conditions can be controlled to provide absorbed energy that is sufficiently high to directly evaporate a portion of the substrate 100 without proceeding through a melting transition. Thermal effects during laser micromachining are further minimized when using pulsed lasers with laser pulses 22P having a pulse duration less than about 100 ps, or less than about 50 ps, or less than about 25 ps. Ablation through non-linear absorption provides a mechanism for removing material from the substrate 100 and enables the formation of a select modification 121 via patterning or formation of fine features in the material that makes up the body 101 of the substrate 100.

As material is dry-ablated from the substrate 100, debris can form and accumulate on the front surface 102 or on the interior surface 153. When forming features 150 in the form of through holes, for example, debris accumulates within the hole. The debris is difficult to remove and can interfere with the ablation process by, for example, scattering the laser beam and preventing attainment of the localized intensity needed for non-linear absorption. To aid removal of debris, liquid-based laser micromachining can be performed as described above. As ablation occurs, the liquid-assist medium 60 displaces debris from the working surface 104 to prevent accumulation of the debris and to provide holes and other features free of clogs. The liquid-assist medium also removes heat from the working surface 104, as noted above. In an example, the liquid-assist medium assists in pushing the core portion 121C out of the body 101 of the substrate.

The vertical placement of the substrate 100 in the liquid-assist medium 60 allows for better liquid convection behind the substrate 100 and, because of the gap G, in front of the substrate 100, and allows for the gas bubbles to easily escape from the rear and the front hole openings.

In previous systems, the front opening of the features may be chipped due to the acoustic-shock component of the ablation process. Embodiments of the present disclosure address this chipping problem due to acoustic-shock by providing the liquid-assist medium 60 in front of the substrate 100 and within the gap. The liquid-assist medium 60 is denser than air, thus diminishing the acoustic-shock effect, which leads to less chipping as compared to the case where the front surface 102 of the substrate 100 is exposed to air. This occurs because of the much smaller characteristic acoustic impedance difference between water-glass compared to air-glass. Thus, embodiments improve the quality of the hole openings at the front surface 102 of the substrate.

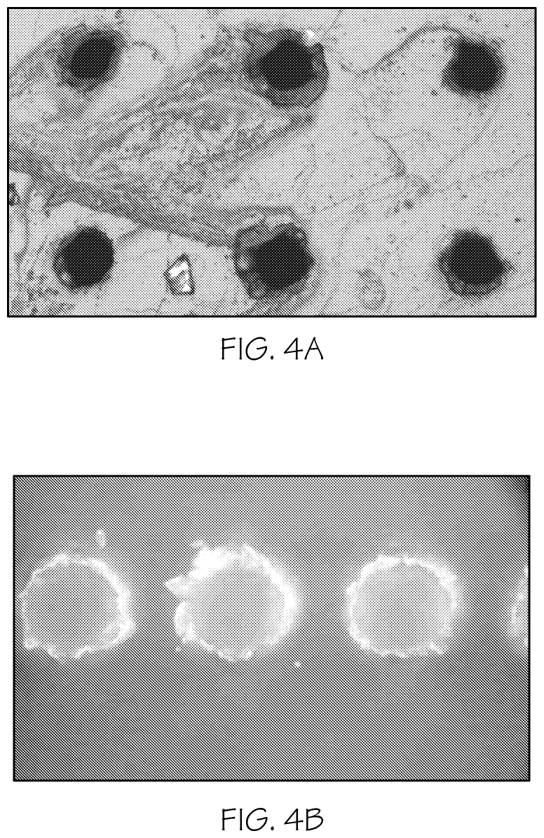

FIGS. 4A and 4B show the front-side openings of 30 μm holes drilled in glass substrates (0.5 mm thick Lotus NXT glass sold by Corning, Inc. of Corning New York) when the front surface was in air and when the front surface was in water, respectively. FIGS. 4A and 4B have the same scale. It is shown that the circular shapes of the holes of FIG. 4B are more well defined than those of FIG. 4A.

Another advantage of the gap G filled with liquid-assist medium 60 is front-surface cleanliness. When the front surface 102 is in air, micro- and nano-particles from the ablation process spill over the front surface 102 when the laser-machined channel breaks through it. In the microscope photo of FIG. 4A, the front surface is shown after the drilling ended. The contamination cannot be washed away because of the strong adhesion of the ablation byproducts to the surface and mechanical finishing is required. When using the system of the present disclosure, the substrate needs rinsing only after completion because the liquid within the gap prevents surface adhesion of debris (see FIG. 4B).

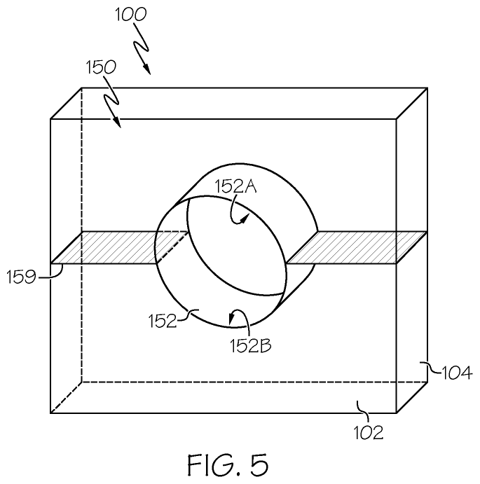

Additionally, the methods described herein provide for high-quality interior walls. Particularly, the presence of the liquid-assist medium 60 at the front surface 102 enables features 150 having walls with a surface roughness of less than or equal to 5 μm, or less than or equal to 2 μm, or less than or equal to 1 μm, or less than or equal to 0.3 μm. The waviness of the walls of the features may be less than or equal to 3 μm, less than equal to 2 μm, or less than or equal to 1 μm. Referring to FIG. 5, the surface roughness and waviness of the wall 152 of a feature 150 may be measured by first dicing the substrate 100 through the feature 150 along a dicing plane 159 and then measuring the wall 152 with an interferometer (e.g., a Zygo interferometer). The opening of the feature 150 allows the wall 152 to measure for surface roughness by an interferometer. The substrate 100 may be diced by any appropriate method, such as mechanically by a dicing blade or by laser ablation.

FIG. 5 also illustrates how the shape of the feature 150 is cylindrical through the thickness of the substrate 100 from the front surface 102 to the second surface 104. The presence of the liquid-assist medium at both the front surface 102 and the back surface 104 enables very small features (e.g., blind or through-holes having a diameter within a range of m to 200 μm including endpoints, a range of 10 μm to 100 μm including endpoints, or a range of 10 μm to 50 μm including endpoints) that have a profile extending from a first surface to a second surface that closely matches a desired profile. For example, a cylindrical hole has a cylindrical profile whereas a square hole as a square profile defined by parallel walls. In embodiments, the profile of the through-hole does deviates less than 5 μm from a predefined profile. Thus, a cylindrical feature fabricated by the methods described herein has a substantially cylindrical profile that deviates less than 5 μm from a cylindrical profile.

A previous method of fabricating small through-features is a laser damage and then etch process wherein a laser first damages a substrate and then an etching bath etches the damaged portion which creates the through-feature. However, this method results in through-features that are hourglass shaped, with the opening at one or both surfaces being larger than a central waist of the through-feature. Conversely, the methods described herein result in a through-feature 150 having a profile that does not deviate from a cylindrical profile by more than 5 μm.

Another aspect of the approach of the present disclosure is the capability of placing the laser-micromachined features in close proximity to one another. Without front surface immersion, there are two factors preventing features (e.g. holes) from being placed close to each other: a) chipping of the neighboring hole and its partial filling with liquid distort and clip the laser beam due to the refractive index spatial variations, and b) the contaminated surface attenuates and scatters the laser beam.

Accordingly, having the gap G filled with the liquid-assist medium 60 enables small features 150 having a diameter of less than or equal to 200 μm and large aspect ratios (e.g., greater than 10:1 (thickness to diameter), greater than 15:1, or greater than 20:1) to be placed close to an edge or one another. An individual feature 150 may be fabricated within 10 μm to 100 μm, including endpoints, from an edge of the substrate 100 and/or an edge of an adjacent feature. The feature 150 will be partially or completely air-filled if drilled with surface 102 in contact with air, i.e. without liquid in the gap G.

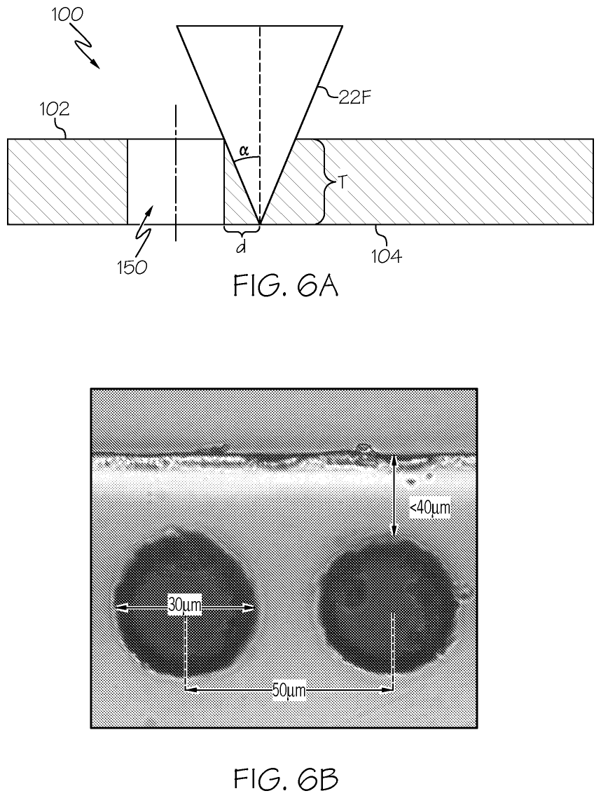

Without liquid in the gap G, the distance d of an edge of an air-filled feature 150 from an edge of a substrate 100 and/or an edge of another feature depends on a thickness TH₂ of the substrate 100 and the focusing angle of the focused laser beam 22F. FIG. 6A illustrates a cross-section of an example substrate 100 having a feature 150 and a focused laser beam 22F in the process of fabricating a second, adjacent feature. The substrate has a thickness TH₂, and the focused laser beam 22F has a ½ angle α. To avoid clipping of the focused laser beam 22F by the feature 150 (or an edge of the substrate 100), the focused laser beam 22F should be positioned accordingly, which ultimately affects the distance d. Thus, the thickness TH₂ of the substrate 100 affects the minimum distance d between edges of adjacent features. More particularly, the minimum distance d may be characterized by:

$$d = T \cdot ( \frac{sin ( arc tg ( NA )}{n} ) ,$$

where α is ½ of a focusing angle of the focused laser beam 22F, tg(α) is NA (numerical aperture of the focused laser beam), and T is the substrate thickness, and n is the refractive index of the substrate, and d is the minimum edge-to-edge distance to the neighboring feature (e.g., through-hole).

FIG. 6B is a microscope image showing the proximity placement advantage of providing liquid-assist media to the front surface during the micromachining process, where 30 μm holes are created in less than 40 μm distance from the edge and approximately 50 μm center-to-center. Embodiments of the present disclose enable circular through-holes to be formed having a dimeter of at least 15 μm. Features may be positioned 40 μm or less from the edge of substrate, with edge-to-edge spacing between features being 20 μm or less. Without being bound by theory, it is believed that this improvement is possible because the refractive index mismatch of about 0.45 between air and glass is reduced to about 0.12 between water and glass.

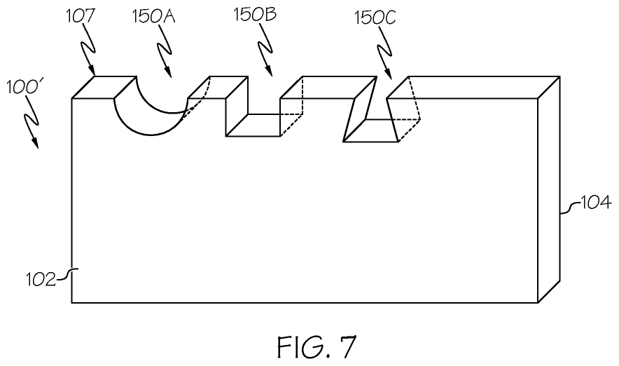

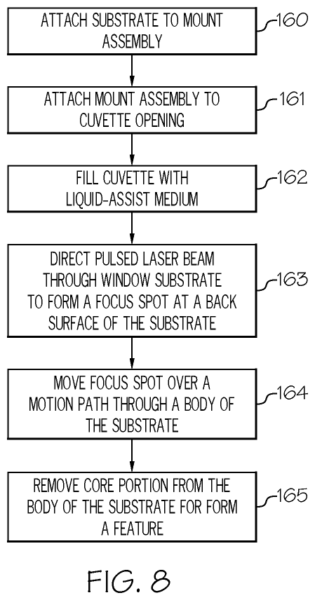

In some embodiments, the system 10 may be used to fabricate features directly on an edge of a substrate. FIG. 7 illustrates a substrate 100′ having three features 150A, 150B, and 150C formed directed in an edge 107 of the substrate 100′ that extends from the first surface 102 to the second surface 104. The formation of a feature on an edge 107 of the substrate 100′ is not possible when the front surface 102 is exposed to air (i.e., without the liquid-filled gap) because of laser beam clipping by the edge of the substrate 100′. The small refractive index mismatch between the liquid-assist material 60 and the substrate material enables such edge features to be fabricated.

Referring now to FIG. 8, a method of processing an article, such as a glass optical interconnection device for optical fibers, is provided. At block 160, a substrate (i.e., a working substrate) is attached to a mount assembly. The mount assembly includes a window-substrate and one or more spacers located at an inner surface of the window-substrate. The mount assembly may further include a cover having an opening, and the window-substrate is hermetically attached to an inner surface of the cover at the opening. The substrate is releasably attached to the one or more spacers such that the substrate may be removed from the mount assembly after laser processing. The material of the one or more spacers is chosen such that the substrate is maintained on the mount assembly during laser processing.

At block 161 the mount assembly is attached to an open end of a cuvette. The mount assembly may be attached by fasteners, such as the fasteners 59 illustrated by FIG. 2A. In some embodiments, a gasket (not shown) may be provided because the cover 53 and the body 51 of the cuvette to hermetically seal the cover 53 to the body 51.

Next, a liquid-assist medium is provided to the interior of the cuvette at block 162. The liquid-assist medium is present within the gap between the window-substrate and the substrate created by the one or more spacers. Thus, the liquid-assist medium contacts both the front surface and the back surface of the substrate.

At block 163, a pulsed laser beam is directed through the window-substrate, the liquid-assist medium within the gap, and the substrate to form a focus spot having an initial position in the liquid-assist medium behind the back surface of the substrate. At block 164 the focus spot is moved over a helical motion path as shown in FIGS. 2C and 2D from the initial position in the liquid-assist medium through a body of the substrate in a general direction from the back surface to the first surface. This creates a modification of a material of the substrate that defines a core portion of the body of the substrate.

After completion of the helical motion path, the core portion of the body is removed to form the feature at block 165 and as shown in FIG. 2E. Any known or yet-to-be-developed method of removing the core may be used. As a non-limiting example, ultrasonic energy may be applied to the substrate to cause the core to drop out of the body. As another example, chemical etching may be used to assist in causing the core to be removed from the body.

A first aspect includes a method of processing a substrate includes disposing the substrate into a liquid-assist medium such that the substrate is in an orientation that is within ten degrees of vertical. The substrate is attached to a mount assembly comprising a window-substrate and one or more spacers located at a surface of the window-substrate. The substrate is attached to the one or more spacers such that a gap is present between a first surface of the substrate and the surface of the window-substrate. The liquid-assist medium is present within the gap and at a back surface of the substrate. The method further includes directing a pulsed laser beam through the window-substrate, the first surface and the back surface to form a focus spot having an initial position in the liquid-assist medium behind the back surface, moving the focus spot over a motion path from the initial position in the liquid-assist medium through a body of the substrate in a general direction from the back surface to the first surface to create a modification of a material of the substrate that defines a core portion of the body of the substrate, and removing the core portion from the body of the substrate to form a feature in the substrate.

A second aspect according to the first aspect, wherein the mount assembly is attached to an opening of a cuvette, and the liquid-assist medium is provided within the cuvette.

A third aspect according to the first or second aspects, the gap has a width within a range of 0.06 mm and 1.6 mm, including endpoints.

A fourth aspect according to any one of the first through third aspect, wherein the substrate has a transmittance of more than 50% at a wavelength of the pulsed laser beam.

A fifth aspect according to any one of the first through fourth aspect, wherein the window-substrate has a transmittance of greater than or equal to 80% at a wavelength of the pulsed laser beam.

A sixth aspect according to any one of the first through fifth aspects, wherein the substrate comprises a glass material, a glass-ceramic material, a crystalline material, or a polymer material.

A seventh aspect according to any one of the first through sixth aspects, wherein the liquid-assist medium has a boiling point greater than or equal to 80° C.

An eighth aspect according to any one of the first through seventh aspects, wherein a difference in a refractive index of the liquid-assist medium and a refractive index of the substrate is less than 0.2.

A ninth aspect according to any one of the first through eighth aspects, wherein the liquid-assist medium has a surface tension of less than or equal to 72 dynes/cm at 25° C.

A tenth aspect according to any one of the first through ninth aspects, wherein the liquid-assist medium is selected from the group consisting of: water, water and added surfactants, fluorinated alkanes, fluorinated alcohols, fluorinated amines, methanol, ethanol, acetone, dimethyl sulfoxide, ethylene glycol, and perfluorinated compounds.

An eleventh aspect according to any one of the first through tenth aspects, wherein the motion path is a helical motion path.

A twelfth aspect according to any one of the first through eleventh aspects, wherein the feature is a circular through-hole having a diameter of at least 15 μm.

A thirteenth aspect according to any one of the first through twelfth aspects, wherein an edge of the feature is less than or equal to 40 μm from an edge of the substrate.

A fourteenth aspect according to any one of the first through thirteenth aspects, wherein an edge-to-edge distance between the features is less than 20 μm.

A fifteenth aspect according to any one of the first through fourteenth aspects, wherein the feature is open at an edge of the substrate.

A sixteenth aspect according to any one of the first through fifteenth aspects, further including indexing a position of the focus spot in a plane parallel to the back surface, moving the focus spot over the motion path from a second initial position in the liquid-assist medium through the body of the substrate in the general direction from the back surface to the first surface to create a second modification of the material of the substrate that defines a second core portion of the body, and removing the second core portion from the body of the substrate to form a second feature in the substrate, wherein a distance between a center of the feature and a center of the second feature is less than 20 μm.

In a seventeenth amendment, a method of processing a substrate includes attaching the substrate to a mount assembly, wherein the mount assembly comprises a window-substrate and one or more spacers located at a surface of the window-substrate, and the substrate is attached to the one or more spacers such that a gap is present between a first surface of the substrate and the surface of the window-substrate. The method further includes attaching the mount assembly to an opening of a cuvette such that the substrate is in an orientation that is within ten degrees of vertical, filling the cuvette with a liquid-assist medium such that the liquid-assist medium is present within the gap and at a back surface of the substrate, wherein the gap has a width within a range of 0.06 mm and 1.6 mm, including endpoints, and directing a pulsed laser beam through the window-substrate, the first surface and the back surface to form a focus spot having an initial position in the liquid-assist medium behind the back surface. A difference in a refractive index of the liquid-assist medium and a refractive index of the substrate is less than 0.2. The method also includes moving the focus spot over a motion path from the initial position in the liquid-assist medium through a body of the substrate in a general direction from the back surface to the first surface to create a modification of a material of the substrate that defines a core portion of the body of the substrate and removing the core portion from the body of the substrate to form a feature in the substrate.

An eighteenth aspect according to the seventeenth aspect, wherein the substrate comprises a glass material, a glass-ceramic material, a crystalline material, or a polymer material.

A nineteenth aspect according to the seventeenth or the eighteenth aspects, wherein the liquid-assist medium has a boiling point greater than 80° C.

A twentieth aspect according to any one of the seventeenth through nineteenth aspects, wherein the liquid-assist medium has a surface tension of less than 72 dynes/cm at 25° C.

A twenty-first aspect according to any one of the seventeenth through twentieth aspect, wherein the liquid-assist medium is selected from the group consisting of: water, water and added surfactants, fluorinated alkanes, fluorinated alcohols, fluorinated amines, methanol, ethanol, acetone, dimethyl sulfoxide, ethylene glycol, and perfluorinated compounds.

A twenty-second aspect according to any one of the seventeenth through twenty-first aspects, wherein the motion path is a helical motion path.

A twenty-third aspect according to any one of the seventeenth through twenty-second aspects, wherein the feature is a circular through-hole having a diameter of at least 15 μm.

A twenty-fourth aspect according to any one of the seventeenth through twenty-third aspects, wherein an edge of the feature is less than or equal to 40 μm from an edge of the substrate.

A twenty-fifth aspect according to any one of the seventeenth through twenty-fourth aspects, wherein the feature is open at an edge of the substrate.

A twenty-sixth aspect according to any one of the seventeenth through twenty-fifth aspects, further including indexing a position of the focus spot in a plane parallel to the back surface, moving the focus spot over the motion path from a second initial position in the liquid-assist medium through the body of the substrate in the general direction from the back surface to the first surface to create a second modification of the material of the substrate that defines a second core portion of the body, and removing the second core portion from the body of the substrate to form a second feature in the substrate, wherein a distance between a center of the feature and a center of the second feature is at least 20 μm.

A twenty-seventh aspect includes a system for processing a substrate that includes a laser system including a laser operable to produce a pulsed laser beam and an optical assembly operable to focus the pulsed laser beam to a focus spot and move the focus spot along a circular path, a three-axis stage, a cuvette mounted to the three-axis stage, the cuvette having an opening in a wall, and a mount assembly having a window-substrate and one or more spacers located at a surface of the window-substrate, wherein the mount assembly is attached to the cuvette such that it seals the opening. The system further includes a substrate mounted to the one or more spacers such that a gap is present between a first surface of the substrate and the surface of the window-substrate, and the substrate is in an orientation that is within ten degrees of vertical. The cuvette is operable to be filled with a liquid-assist medium such that the liquid-assist medium is present within the gap and at the back surface of the substrate.

A twenty-eighth aspect according to the twenty-seventh aspect, wherein the gap has a width within a range of 0.06 mm and 1.6 mm, including endpoints.

A twenty-ninth aspect according to the twenty-seventh or the twenty-eighth aspects, wherein the substrate has a transmittance of more than 50% at a wavelength of the pulsed laser beam.

A thirtieth aspect according to any one of the twenty-seventh through twenty-ninth aspects, wherein the window-substrate has a transmittance of more than 80% at a wavelength of the pulsed laser beam.

A thirty-first aspect according to any one of the twenty-seventh through thirtieth aspects, wherein the substrate comprises a glass material, a glass-ceramic material, a crystalline material, or a polymer material.

A thirty-second aspect includes an article including a first surface, a second surface opposite the first surface such that the article has a thickness between the first surface and the second surface, and a through-hole extending from the first surface to the second surface. The through-hole has a diameter of less than 200 μm. An aspect ratio of the thickness to the diameter is at least 10:1. The through-hole has a profile from the first surface to the second surface that deviates less than 5 μm from a predefined profile.

A thirty-third aspect according to the thirty-second aspect, wherein the profile deviates less than 2 μm from the predefined profile.

A thirty-fourth aspect according to the thirty-second aspect or the thirty-third aspect, wherein the profile deviates less than 1 μm from the predefined profile.

A thirty-fifth aspect according to any one of the thirty-second through thirty-fourth aspects, wherein the article further comprises an edge, and an edge of the through-hole is within a range of 10 μm and 100 μm, including endpoints, from the edge.

A thirty-sixth aspect according to any one of the thirty-second through thirty-fifth aspects, further including a second through-hole wherein an edge of the second through-hole is separated from an edge of the through-hole by a distance that is within a range of 10 μm and 100 μm, including endpoints.

A thirty-seventh aspect according to any one of the thirty-second through thirty-sixth aspects, further including a second through-hole wherein an edge of the second through-hole contacts an edge of the through-hole.

A thirty-eighth aspect according to any one of the thirty-second through thirty-seventh aspects, wherein the article comprises a glass material, a glass-ceramic material, a crystalline material, or a polymer material.

A thirty-ninth aspect according to any one of the thirty-second through thirty-eighth aspects, wherein the article is a fiber holder.

A fortieth aspect includes an article including a first surface, a second surface opposite the first surface such that the article has a thickness between the first surface and the second surface, and a first through-hole and a second through-hole extending from the first surface to the second surface. The first through-hole and the second through-hole each have a diameter of less than 200 μm, and an edge of the first through-hole is within a range of 10 μm and 100 μm, including endpoints, from an edge of the second through-hole.

A forty-first aspect according to the fortieth aspect, wherein an aspect ratio of the thickness to the diameter is at least 10:1, and the first through-hole and the second through-hole each have a profile from the first surface to the second surface that deviates less than 5 μm from a predefined profile.

A forty-second aspect according to the forty-first aspect, wherein the profile deviates less than 2 μm from the predefined profile.

A forty-third aspect according to the forty-first aspect, wherein the profile deviates less than 1 μm from the predefined profile.

A forty-fourth aspect according to any one of the fortieth through forty-third aspects, wherein the article comprises a glass material, a glass-ceramic material, a crystalline material, or a polymer material.

A forth-fifth aspect according to any one of the fortieth through forty-fourth aspects, wherein the article is a fiber holder.

It is noted that recitations herein of a component of the embodiments being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the embodiments of the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Although the disclosure has been illustrated and described herein with reference to explanatory embodiments and specific examples thereof, it will be readily apparent to those of ordinary skill in the art that other embodiments and examples can perform similar functions and/or achieve like results. For instance, the connection port insert may be configured as individual sleeves that are inserted into a passageway of a device, thereby allowing the selection of different configurations of connector ports for a device to tailor the device to the desired external connector. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

1. A method of processing a substrate, the method comprising:
disposing the substrate into a liquid-assist medium such that the substrate is in an orientation that is within ten degrees of vertical, wherein:
the substrate is attached to a mount assembly comprising a window-substrate and one or more spacers located at a surface of the window-substrate;
the substrate is attached to the one or more spacers such that a gap is present between a first surface of the substrate and the surface of the window-substrate; and
the liquid-assist medium is present within the gap and at a back surface of the substrate;
directing a pulsed laser beam through the window-substrate, the first surface and the back surface to form a focus spot having an initial position in the liquid-assist medium behind the back surface;
moving the focus spot over a motion path from the initial position in the liquid-assist medium through a body of the substrate in a general direction from the back surface to the first surface to create a modification of a material of the substrate that defines a core portion of the body of the substrate; and
removing the core portion from the body of the substrate to form a feature in the substrate.

2. The method of claim 1, wherein the mount assembly is attached to an opening of a cuvette, and the liquid-assist medium is provided within the cuvette.

3. The method of claim 1, wherein the gap has a width within a range of 0.06 mm and 1.6 mm, including endpoints.

4. (canceled)

5. The method of claim 1, wherein the substrate has a transmittance of more than 50% at a wavelength of the pulsed laser beam; and
the window-substrate has a transmittance of greater than or equal to 80% at a wavelength of the pulsed laser beam.

6. (canceled)

7. The method of claim 1, wherein the liquid-assist medium has a boiling point greater than or equal to 80° C.; and
the liquid-assist medium has a surface tension of less than or equal to 72 dynes/cm at 25° C.

8. The method of claim 1, wherein a difference in a refractive index of the liquid-assist medium and a refractive index of the substrate is less than 0.2.

9. (canceled)

10. (canceled)

11. The method of claim 1, wherein the motion path is a helical motion path.

12. The method of claim 1, wherein the feature is a circular through-hole having a diameter of at least 15 μm.

13. The method of claim 1, wherein an edge of the feature is less than or equal to 40 μm from an edge of the substrate.

14. The method of claim 1, wherein an edge-to-edge distance between the features is less than 20 μm.

15. The method of claim 1, wherein the feature is open at an edge of the substrate.

16. The method of claim 1, further comprising:
indexing a position of the focus spot in a plane parallel to the back surface;
moving the focus spot over the motion path from a second initial position in the liquid-assist medium through the body of the substrate in the general direction from the back surface to the first surface to create a second modification of the material of the substrate that defines a second core portion of the body; and
removing the second core portion from the body of the substrate to form a second feature in the substrate, wherein a distance between a center of the feature and a center of the second feature is less than 20 μm.

17.-26. (canceled)

27. A system for processing a substrate, the system comprising:
a laser system comprising a laser operable to produce a pulsed laser beam and an optical assembly operable to focus the pulsed laser beam to a focus spot and move the focus spot along a circular path;
a three-axis stage;
a cuvette mounted to the three-axis stage, the cuvette comprising an opening in a wall;
a mount assembly comprising a window-substrate and one or more spacers located at a surface of the window-substrate, wherein the mount assembly is attached to the cuvette such that it seals the opening; and
a substrate mounted to the one or more spacers such that a gap is present between a first surface of the substrate and the surface of the window-substrate, and the substrate is in an orientation that is within ten degrees of vertical, wherein the cuvette is operable to be filled with a liquid-assist medium such that the liquid-assist medium is present within the gap and at the back surface of the substrate.

28. The system of claim 27, wherein the gap has a width within a range of 0.06 mm and 1.6 mm, including endpoints.

29. The system of claim 27, wherein:
the substrate has a transmittance of more than 50% at a wavelength of the pulsed laser beam; and
the window-substrate has a transmittance of more than 80% at a wavelength of the pulsed laser beam.

30. (canceled)

31. (canceled)

32. An article comprising:
a first surface;
a second surface opposite the first surface such that the article has a thickness between the first surface and the second surface;
a through-hole extending from the first surface to the second surface, wherein:
the through-hole has a diameter of less than 200 μm,
an aspect ratio of the thickness to the diameter is at least 10:1, and
the through-hole has a profile from the first surface to the second surface that deviates less than 5 μm from a predefined profile.

33. The article of claim 32, wherein the profile deviates less than 2 μm from the predefined profile.

34. (canceled)

35. The article of claim 32, wherein the article further comprises an edge, and an edge of the through-hole is within a range of 10 μm and 100 μm, including endpoints, from the edge.

36. The article of claim 32, further comprising a second through-hole wherein an edge of the second through-hole is separated from an edge of the through-hole by a distance that is within a range of 10 μm and 100 μm, including endpoints.

37. The article of claim 32, further comprising a second through-hole wherein an edge of the second through-hole contacts an edge of the through-hole.

38.-45. (canceled)
